(19) United States
(12) Patent Application Publication
(10) Pub. No.: US 2026/0118234 A1
(43) Pub. Date: Apr. 30, 2026

(54) APPARATUS FOR SEPARATING A PARTICLE AND METHODS OF MANUFACTURE THEREOF

(71) Applicant: Germspot, Inc., Bedford, NH (US)

(72) Inventors: Tad Witkowicz, Bedford, NH (US); Slawek Antoszczyk, Bedford, NH (US)

(73) Assignee: Germspot, Inc., Bedford, NH (US)

(21) Appl. No.: 19/367,948

(22) Filed: Oct. 24, 2025

Related U.S. Application Data
(60) Provisional application No. 63/711,546, filed on Oct. 24, 2024.

(51) Int. Cl. G01N 1/40

(52) U.S. Cl. CPC G01N 1/4005

(57) ABSTRACT

An apparatus for separating a particle includes a sample-holding portion, a filter-holding portion, and a filtering portion. The sample-holding portion includes a first inlet configured to receive a fluid sample, a cavity configured to contain the fluid sample, a first clamping feature having a first clamping surface, and a first outlet disposed within the first clamping surface. The filter-holding portion includes a second clamping feature having a second clamping surface facing opposite the first clamping surface, a second inlet disposed within the second clamping surface and aligned with the first outlet, and a second outlet. The filtering portion is securely disposed between the first clamping surface and the second clamping surface and configured to filter the particle from the fluid sample that passes between the first outlet and the second inlet.

### CROSS-REFERENCE TO RELATED APPLICATIONS

This application claims the benefit of priority of U.S. Provisional Patent Application Ser. No. 63/711,546, filed on Oct. 24, 2024, and titled “APPARATUS FOR SEPARATING A PARTICLE AND METHODS OF MANUFACTURE THEREOF,” which is incorporated by reference herein in its entirety.

### FIELD OF THE INVENTION

The present invention generally relates to the field of biological apparatus. In particular, the present invention is directed to apparatus for separating a particle and methods of manufacture thereof.

### BACKGROUND

In the fields of biotechnology, pharmaceuticals, and clinical medicine, there is a critical need for rapid and accurate detection of microbial contamination in materials, drug substances, and drug, among others. Traditional sterility testing methods may take anywhere one to fourteen days to produce reliable results. This time frame may be impractical for certain drug therapies that have a relatively short shelf life-which may sometimes be only a few hours to a few days-before they lose their efficacy. Such delay in obtaining sterility results may hinder the timely administration of these therapies to patients, potentially compromising treatment outcomes. As a result, existing methods of sterility testing are not satisfactory.

Current methods for sterility testing often involve filtering the material to be tested, placing the filter onto a growth medium in a Petri dish, and incubating the sample for a period ranging from one to fourteen days. The presence of microbial contamination may then be determined by an appearance of bacterial colonies on the filter. This method, while reliable, is often time-consuming, prone to manual errors, and ill-suited for applications where rapid results are necessary.

### SUMMARY OF THE DISCLOSURE

In an aspect, an apparatus for separating a particle is described. The apparatus includes a sample-holding portion, a filter-holding portion, and a filtering portion. The sample-holding portion includes a first inlet configured to receive a fluid sample, a cavity configured to contain the fluid sample, a first clamping feature having a first clamping surface, and a first outlet disposed within the first clamping surface. The filter-holding portion includes a second clamping feature having a second clamping surface facing opposite the first clamping surface, a second inlet disposed within the second clamping surface and aligned with the first outlet, and a second outlet. The filtering portion is securely disposed between the first clamping surface and the second clamping surface and configured to filter the particle from the fluid sample that passes between the first outlet and the second inlet.

In another aspect, a method for manufacturing an apparatus that separates a particle is described. The method includes providing a sample-holding portion. The sample-holding portion includes a first inlet configured to receive a fluid sample, a cavity configured to contain the fluid sample, a first clamping feature having a first clamping surface, and a first outlet disposed within the first clamping surface. The method further includes providing a filter-holding portion. The filter-holding portion includes a second clamping feature having a second clamping surface facing opposite the first clamping surface, a second inlet disposed within the second clamping surface and aligned with the first outlet, and a second outlet. The method further includes providing a filtering portion, wherein the filtering portion is configured to filter the particle from the fluid sample. The method further includes assembling the sample-holding portion, the filter-holding portion, and the filtering portion by engaging the second clamping surface against the first clamping surface, wherein filtering portion is securely disposed between the first clamping surface and the second clamping surface.

These and other aspects and features of nonlimiting embodiments of the present invention will become apparent to those skilled in the art upon review of the following description of specific nonlimiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic cross-sectional view of an exemplary embodiment of an apparatus for separating a particle;

FIG. 2 is a flow diagram of an exemplary embodiment of a method of manufacturing an apparatus that separates a particle; and

FIG. 3 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to an apparatus for separating a particle from a fluid sample and methods of manufacture thereof. In one or more embodiments, the particle may include a microbe or a microbial contaminant. In some cases, such microbe or microbial contaminant may include a bacterium, a fungus, or the like. In one or more embodiments, the particle may include nonliving matter such as without limitation a microplastic particle.

The apparatus includes a sample-holding portion. In one or more embodiments, at least a fraction of the sample-holding portion may include a shape of a cylinder, a prism, or the like. The sample-holding portion includes a first inlet configured to receive a fluid sample. The sample-holding portion further includes a cavity configured to contain the fluid sample. In one or more embodiments, the cavity may include a volume between 1 microliter (μL) and 10 milliliters (mL). The sample-holding portion further includes a first clamping feature having a first clamping surface. The sample-holding portion further includes a first outlet disposed within the first clamping surface. In one or more embodiments, the first outlet may be disposed opposite to the first inlet. In one or more embodiments, the first outlet may include a size between 50 micrometers and 1 centimeter.

The apparatus further includes a filter-holding portion. The filter-holding portion includes a second clamping feature having a second clamping surface facing opposite the first clamping surface. The filter-holding portion further includes a second inlet disposed within the second clamping surface and aligned with the first outlet. The filter-holding portion further includes a second outlet. In one or more embodiments, the second outlet may be disposed opposite to the second inlet. In one or more embodiments, the second outlet may be configured to connect to a pump configured to increase a flow rate of the fluid sample. In one or more embodiments, the filter-holding portion may further include a distal surface opposite to the second clamping surface. In some cases, the second outlet may be disposed within the distal surface.

The apparatus further includes a filtering portion. The filtering portion is securely disposed between the first clamping surface and the second clamping surface and configured to filter the particle from the fluid sample that passes between the first outlet and the second inlet. In one or more embodiments, the filtering portion may include a semi-permeable membrane having a pore size between 50 nanometers and 20 micrometers. In some cases, such semi-permeable membrane may be constructed using one or more materials such as without limitation polycarbonate (PCTE), cellulose nitrate (CN), cellulose acetate (CA), mixed cellulose ester (MCE), polyethersulfone (PES), polypropylene (PP), nylon, regenerated cellulose, glass microfiber, and/or aluminum oxide, among others. In one or more embodiments, the filtering portion may further include a housing element, wherein the semi-permeable membrane is disposed within the housing element. In some cases, such housing element may be constructed using one or more materials such as without limitation polypropylene (PP), acrylic including acrylic copolymer, polystyrene (PS), and/or polycarbonate (PC), stainless steel, and various metals, such as aluminum, copper, chromium, titanium, etc., among others.

In one or more embodiments, the apparatus may further include a securing mechanism configured to engage the second clamping surface against the first clamping surface, such without limitation by applying a pressure. In some cases, the securing mechanism may include a screwing mechanism. Specifically, the sample-holding portion may include at least a first mounting slot, and the filter-holding portion may include at least a second mounting slot aligned with the at least a first mounting slot. The securing mechanism may accordingly include at least a screw configured to secure the filter-holding portion against the sample-holding portion by penetrating the at least a first mounting slot and the at least a second mounting slot. In some cases, the securing mechanism may include at least a clamp.

In one or more embodiments, the apparatus may further include a sealing element configured to keep the filtering portion in place.

In one or more embodiments, the apparatus may include at least a first mating feature complementary to at least a second mating feature in a detection system, thereby allowing the apparatus to be securely integrated within the detection system for measurement. In some cases, the detection system may include a microscope such as without limitation a fluorescence microscope.

Aspects of the present disclosure can be used as cartridges to concentrate and/or localize a microbial contamination for rapid sterility testing and provide reliable results within minutes rather than days. Aspects of the present disclosure may allow for particles, such as microbes, of a low concentration to be isolated and captured with a unity or near-unity yield. Aspects of the present disclosure may be implemented as modular units compatible with detection systems, such as without limitation fluorescence microscopes, and facilitate an easy observation and/or quantification of particles and/or microbes. Aspects of the present disclosure may provide efficient clinical decision supports for use cases such as without limitation cell therapy and/or gene therapy. For purposes of description herein, relating terms, including “top”, “bottom”, “left”, “right”, “front”, “back”, “vertical”, “horizontal”, and derivatives thereof are defined from the perspective of a hypothetical person operating the apparatus described herein.

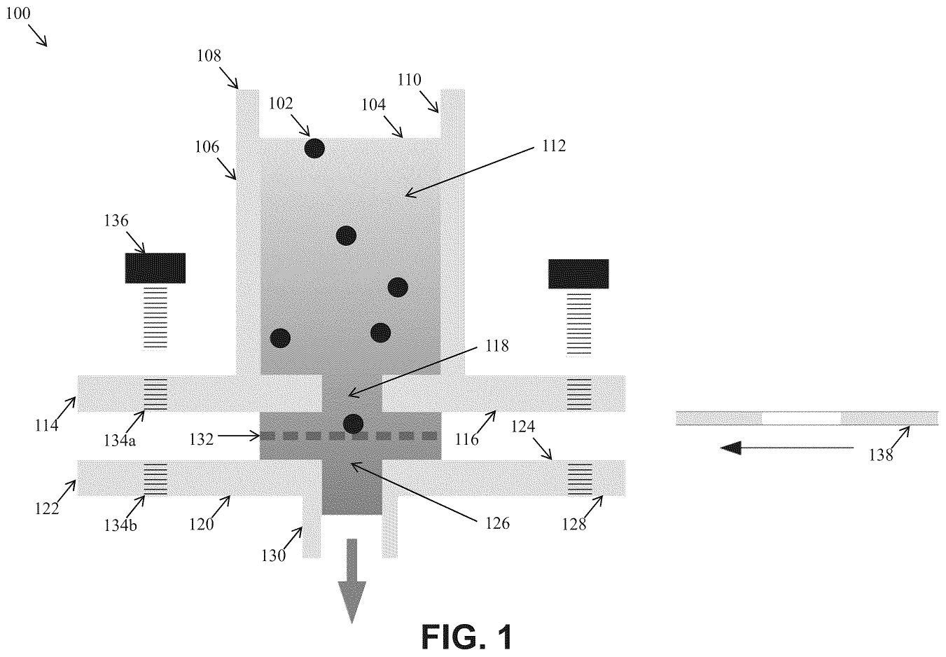

Referring now to FIG. 1, an apparatus 100 for separating a particle 102 from a fluid sample 104 is illustrated. For the purposes of this disclosure, a “particle” is a substance of sufficiently small dimensions that is capable of being dispersed in a medium. A particle may include living matter such as without limitation a microbe or a microbial contaminant. For the purposes of this disclosure, a “microbe” is an organism of microscopic size. A microbe may exist in its single-celled form or as a clusters of cells (except for viruses that do not have cellular structures) and may potentially function as a pathogen and infect a host to result in one or more symptoms. “Microbe” and “microorganism” may be used interchangeably throughout this disclosure.

With continued reference to FIG. 1, microbes may include viruses such as without limitation Rhinovirus, Adenovirus, Human Immunodeficiency Virus (HIV), Hepatitis B Virus (HBV), Hepatitis C Virus (HCV), Herpes Simplex Virus (HSV-1 and HSV-2), Varicella-Zoster Virus (VZV), Human Papillomavirus (HPV), Influenza Virus, Parainfluenzavirus, Respiratory Syncytial Virus (RSV), SARS-CoV-2, Cytomegalovirus (CMV), Epstein-Barr Virus (EBV), Zika Virus, Dengue Virus, Ebola Virus, Rabies Virus, Measles Virus, Mumps Virus, Rubella Virus, Human T-cell Lymphotropic Virus (HTLV), and/or Norovirus, among others. Microbes may include one or more species or genera of bacteria, such as without limitation Escherichia coli, Streptococcus including Streptococcus pyogenes and Streptococcus pneumoniae, Staphylococcus aureus, Pseudomonas aeruginosa, Clostridium difficile, Mycobacterium tuberculosis, Neisseria meningitidis, Helicobacter pylori, Klebsiella pneumoniae, Salmonella enterica, Vibrio cholerae, Bacillus anthracis, Shigella dysenteriae, Haemophilus influenzae, Listeria monocytogenes, Treponema pallidum, Chlamydia trachomatis, Borrelia burgdorferi, Legionella pneumophila, Corynebacterium diphtheriae, and/or Campylobacter jejuni, among others. Microbes may include one or more species or genera of fungi, such as without limitation Candida albicans, Aspergillus fumigatus, Cryptococcus neoformans, Histoplasma capsulatum, Coccidioides immitis, Blastomyces dermatitidis, Pneumocystis jirovecii, Trichophyton rubrum, Microsporum canis, Epidermophyton floccosum, Malassezia furfur, Sporothrix schenckii, Paracoccidioides brasiliensis, Rhizopus oryzae, and/or Fusarium solani, among others. Microbes may include endospores of certain bacteria, fungi, and conidiophore, and/or algae. Additionally, and/or alternatively, microbes may include other types of microorganisms not disclosed herein but deemed relevant to apparatus 100 by a person of ordinary skill in the art, upon reviewing the entirety of this disclosure. Microbes may be of a variety of sizes; for example, viruses are typically between 20 nanometers and 400 nanometers, bacteria are typically between 1 micrometer and 100 micrometers, whereas fungi are typically between 10 micrometers and 100 micrometers, sometimes up to several millimeters. As a nonlimiting example, Mycoplasmas, a genus of bacteria, are typically between 300 nanometers and 800 nanometers. Apparatus 100 and/or filtering element therein may be configured accordingly based on the size of microbe or microbes it is intended to filter, as described in detail below.

With continued reference to FIG. 1, for the purposes of this disclosure, a “microbial contaminant” is an undesirable presence of one or more microbes in a substance or environment. In some cases, whether a microbe may be considered a microbial contaminant may depend on the context. As a nonlimiting example, a microbe may be considered microbial contaminant in one context but not in another. In some cases, a substance or environment may be required to be sterile. For the purposes of this disclosure, “sterile” is a descriptor indicating a complete absence of all forms of life, which include microorganisms such as without limitation bacteria, viruses, fungi, and/or endospores, among others. Sterility often is achieved through processes such as autoclaving, filtration, and/or chemical disinfection, among others, and is often essential in medical procedures, drug manufacturing, cell and gene therapies to prevent infection and contamination. Sterile conditions may be critical in surgeries, injections, and wound care to protect patients from harmful pathogens. In some other cases, a medical product, substance, equipment, and/or the like may be only required to be “aseptic” or “near sterile”. Such conditions may be particularly relevant for biotechnology or pharmaceutical processes. For the purposes of this disclosure, “aseptic” or “near sterile” is a descriptor often used to describe a not completely sterile state where the load of a microbe is reduced to an extremely low level. In an “aseptic” or “near sterile” state, the concentration of microorganisms is below a certain acceptable threshold, typically deemed safe for medical procedures, but without the complete elimination of all microbes. Aseptic techniques often aim to prevent contamination from pathogens but may not guarantee a complete absence of all microorganisms, as in sterility. Accordingly, for the purposes of this disclosure, a “sterility test” a procedure used to determine whether a medical product, substance, or equipment is free from viable microorganisms. It is commonly performed on pharmaceuticals, biological products, and/or surgical tools, among others to ensure they are sterile before being used in clinical settings. A sterility test typically involves incubating an item, such as a tested sample, in a nutrient-rich medium to detect any microbial growth. Such a test may be implemented according to protocols described in United States Pharmacopeia General Chapter 71 (also known as USP 71). If no growth is observed after a specified period, the item may be considered sterile. In a clinical context, a sterility test is often critical in ensuring patient safety by preventing infections. In some cases, a sterility test may also be used to determine whether medical product, substance, or equipment is aseptic/near sterile. However, a sterility testing procedure is often time-consuming, and a faster method of sterility testing is urgently needed to ensure that drug products are free of microbial contamination before they are administered to patients. In some cases, a sterility test may also be used in non-clinical contexts such as without limitation an evaluation of food and/or cosmetic products. Additional details will be provided below in this disclosure.

With continued reference to FIG. 1, it worth noting that apparatus 100 is not limited to separating living matter only. In contrary, apparatus 100 may be used to isolate any particle of interest dispersed in a fluid medium, as recognized by a person of ordinary skill in the art, upon reviewing the entirety of this disclosure. As a nonlimiting example, particle 102 may include a microplastic particle. For the purposes of this disclosure, a “microplastic particle” is a plastic fragment, typically less than 5 millimeters in size, that results from the breakdown of larger plastic items and/or is manufactured at a small size for use in products. Microplastic particles may be found in various environments, including without limitation oceans, freshwater systems, soil, and even the atmosphere. Microplastics can pose significant environmental and health risks due to their persistence, potential to absorb toxins, and ability to be ingested by wildlife and humans. Microplastics may in some cases have a strong absorption at certain wavelengths of the electromagnetic radiation and may be detected using ultraviolet light and/or other spectroscopic techniques.

With continued reference to FIG. 1, for the purposes of this disclosure, a “fluid sample” is an amount of fluid without a definite volume and/or shape. Fluid sample 104 may include without limitation any type of fluid in which sterility or near sterility is required or desired. Fluid sample 104 may contain one or more particles 102 that apparatus 100 is intended to separate, as part of a sterility test, consistent with details described above. Fluid sample 104 may include without limitation a liquid sample, such as water, an aqueous solution, or a nonaqueous solution. Fluid sample 104 may include without limitation a food product. Fluid sample 104 may include a gaseous sample, such as without limitation an air sample from a hospital or a clean room where sterility is required. Fluid sample 104 may include without limitation a pharmaceutical solution (e.g., injectable drugs, intravenous fluids, etc.). Fluid sample 104 may include biological products (e.g., vaccines, serum, plasma, etc.), which may in some cases be used for cell/gene therapy. Fluid sample 104 may include without limitation dialysis fluids used in medical treatments. Fluid sample 104 may include without limitation nutritional fluids for parenteral nutrition. Fluid samples may include without limitation clinical samples such as without limitation a cell sample, saliva, sweat, urine, blood, etc. Fluid sample 104 may include without limitation ophthalmic solutions (e.g., eye drops). Fluid sample 104 may include without limitation a sample of a cosmetic product. Fluid sample 104 may include irrigation fluids used in surgeries. A fluid sample may include without limitation culture media for research and clinical purposes.

With continued reference to FIG. 1, in some cases, apparatus 100 may be used to perform a sterility test on water. As a nonlimiting example, sterile water may be required in applications such as without limitation pharmaceutical manufacturing, such as without limitation for producing injectable drugs and sterile formulations. As another nonlimiting example, sterile water may be required laboratory research, such as without limitation for preparing reagents and solutions in experiments to avoid contamination and/or for cooling high-precision instruments. As another nonlimiting example, sterile water may be required in medical devices, such as without limitation for rinsing and sterilizing surgical instruments, equipment, and/or facilities, such as without limitation rooms, surfaces, and air UV lamps. Surgical instruments may be sterilized by steam sterilization at 132° C.; under such a temperature, any steam will become sterile. Surgical instruments may be sterilized using gamma radiation, such as without limitation by applying a radiation at an intensity of tens of thousands of Gy. As another nonlimiting example, sterile water may be required for dialysis, such as without limitation in the preparation of dialysis fluids for patients with kidney failure. As another nonlimiting example, sterile water may be required for cell culture, such as without limitation when cells culture in a sterile environment. As another nonlimiting example, sterile water may be required in clinical settings, such as without limitation wound irrigation and injections.

With continued reference to FIG. 1, in one or more embodiments, at least a portion of apparatus 100 may be constructed using disposable materials such as without limitation glass or plastics. In one or more embodiments, at least a portion of apparatus 100 may be constructed using biodegradable materials such as without limitation polylactic acid, polyhydroxyalkanoates (PHA), polybutylene Succinate (PBS), polycaprolactone (PCL), and/or the like. Additional details will be provided below. In one or more embodiments, at least a portion of apparatus 100 may be constructed or manufactured using techniques such as molding including without limitation injection molding and compression molding, extrusion, 3D printing including stereolithography and other additive manufacturing techniques similar thereto, computer numerical control (CNC) machining, laser cutting and welding, thermoforming, casting, surface coating and finishing, among others. As a nonlimiting example, at least a portion of apparatus 100 may be coated with an anti-fouling coating layer to prevent undesired adhesion of microbes and/or growth of biofilms. A person of ordinary skill in the art, upon reviewing the entirety of this disclosure, will be able to recognize suitable manufacturing techniques for different parts of apparatus 100.

With continued reference to FIG. 1, apparatus 100 includes a sample-holding portion 106. For the purposes of this disclosure, a “sample-holding portion” is a device configured to accept and contain a sample. Sample-holding portion may be constructed using any material or combination of materials deemed suitable by a person of ordinary skill in the art, upon reviewing the entirety of this disclosure. Suitable material or combination of materials may have both sufficient rigidity and sufficient flexibility (i.e., elasticity). Suitable material or materials may not only support the weight of and/or tolerate the tension within apparatus 100 while holding its components in place, but also withstand temporary deformation from their resting positions without cracking when assembled, disassembled, and/or subject to a pressure or pressure difference (e.g., connected to a suction pump). As nonlimiting examples, at least a portion of sample-holding portion 106 may be constructed using glass, quartz, plant materials such as wood or bamboo, metals or metal alloys including but not limited to iron, manganese, nickel, copper, molybdenum, vanadium, silicon, titanium and/or aluminum, comparably robust synthetic and/or polymeric materials such as polyethylene (PE), polyethylene terephthalate (PETE), polypropylene (PP), polyvinyl chloride (PVC), polyvinylidene fluoride (PVDF), polytetrafluoroethylene (PTFE), poly (methyl methacrylate) (PMMA), polyimides (PIs), polydimethylsiloxane (PDMS), and resins, composite materials such as fiberglass, any combination thereof, and/or the like. In some cases, at least a part within sample-holding portion 106 may include one or more internal voids to add lightness, making it easier to transport. In one or more embodiments, one or more elements within sample-holding portion 106 may include one or more internal bracing elements, such as triangular bracing made up of sheets or walls using one or more rigid materials. Bracing elements and voids may form any suitable configuration, including without limitation honeycomb construction. Such bracing may increase structural strength of an element while retaining lightness of construction introduced by one or more voids. In some cases, at least a part of sample-holding portion 106 may be constructed using one or more transparent materials such as without limitation glass, treated glass including laminated safety glass, or plexiglass including, but not limited to, Lexan polycarbonate, acrylic plastics including stretched acrylic, reinforced glass, and/or the like.

With continued reference to FIG. 1, in one or more embodiments, at least a fraction of sample-holding portion 106 may include a shape of a cylinder, a prism, or the like. As nonlimiting examples, at least part of sample-holding portion 106 may have a shape of a right rectangular prism/right square prism, triangular prism, pentagonal prism, hexagonal prism, octagonal prism, parallelepiped, rhombohedron, trigonal trapezohedron, right or oblique circular cylinder, elliptic cylinder, truncated sphere, truncated ellipsoid, or another geometry similar thereto. In some cases, at least part of sample-holding portion 106, including without limitation the cavity therein, as described below, may have an axial symmetry, such as without limitation a 2-fold, a 4-fold symmetry, a 6-fold symmetry, an 8-fold symmetry, or a cylindrical symmetry. Similarly, sample-holding portion 106 may adopt any shape at one or more of its facets or cross-sectional areas, such as without limitation a circular shape, an elliptical shape, a polygonal shape, and/or the like.

With continued reference to FIG. 1, in one or more embodiments, sample-holding portion 106 may include at least a sidewall 108. For the purposes of this disclosure, a “sidewall” is a boundary located at neither the top nor the bottom of sample-holding portion 106 that spatially defines its inside from its outside. In one or more embodiments, a sidewall may be a back wall, a front wall, a left wall, or a right wall. In some cases, a sidewall may be flat or substantially flat. In some other cases, a sidewall may have a curvature visible to the naked eye. In some cases, there may be no clear demarcations between different “front”, “back”, “left”, or “right” walls; as a nonlimiting example, for a sample-holding portion 106 with a cylindrical shape or the like, a sidewall may be a continuous surface (i.e., a belt) that merges “front”, “back”, “left”, and “right” walls altogether. In some cases, one or more sidewalls may have a uniform thickness across a plurality of locations within sample-holding portion 106. In some cases, one or more portions of one or more sidewalls may be constructed to be thicker or thinner than others, depending on the specific needs of different use cases. As a nonlimiting example, a sidewall may include without limitation a thickness between 0.5 millimeter and 5 millimeters in order to impart sufficient mechanical strength to apparatus 100 without introducing unnecessary material cost.

With continued reference to FIG. 1, sample-holding portion 106 includes a first inlet 110 configured to receive fluid sample 104. For the purposes of this disclosure, an “inlet” is an opening within a device through which a certain amount of matter can be loaded. First inlet 110 may be disposed at any location within the exterior of sample-holding portion 106 that is deemed suitable by a person of ordinary skill in the art, upon reviewing the entirety of this disclosure. As nonlimiting examples, first inlet 110 may be disposed at the top of sample-holding portion 106, within a sidewall 108 of the sample-holding portion 106, at the front of the sample-holding portion 106, at the back of the sample-holding portion 106, on the left side of the sample-holding portion 106, on the right side of sample-holding portion, etc. Fluid sample 104 may be loaded into sample-holding portion 106, via first inlet 110, using a beaker, an Erlenmeyer flask, a syringe, a pipeteman, a serological pipette, or the like. In some cases, fluid sample 104 may be loaded using an autopipette, which may be controlled and automated by a computing device.

With continued reference to FIG. 1, sample-holding portion 106 further includes a cavity 112 configured to contain fluid sample 104. For the purposes of this disclosure, a “cavity” is an enclosed, empty space with a capacity to contain an amount of matter. Cavity 112 may include any shape or geometry described above without limitation. In one or more embodiments, cavity 112 may include a volume between 1 microliter (μL) and 10 milliliters (mL). As nonlimiting examples, cavity 112 may include a volume between 1 μL and 2 μL, between 2 μL and 3 μL, between 3 μL and 4 μL, between 4 μL and 5 μL, between 5 μL and 6 μL, between 6 μL and 7 μL, between 7 μL and 8 μL, between 8 μL and 9 μL, between 9 μL and 10 μL, between 10 μL and 20 μL, between 20 μL and 30 μL, between 30 μL and 40 μL, between 40 μL and 50 μL, between 50 μL and 100 μL, between 100 μL and 200 μL, between 200 μL and 300 μL, between 300 μL and 400 μL, between 400 μL and 500 μL, between 500 μL and 600 μL, between 600 μL and 700 μL, between 700 μL and 800 μL, between 800 μL and 900 μL, between 900 μL and 1 mL, between 1 mL and 2 mL, between 2 mL and 5 mL, or between 5 mL and 10 mL.

With continued reference to FIG. 1, sample-holding portion 106 further includes a first clamping feature 114. For the purposes of this disclosure, a “clamping feature” is a structural element with at least a contact surface that is capable of securing another element in place, often through friction, by applying pressure onto it. A clamping feature may be paired with at least another clamping feature to apply pressure in opposing directions in order to perform its clamping function. In some cases, first clamping feature 114 may protrude from sample-holding portion 106, as shown in FIG. 1, in order to create an extended contact area. In some other cases, first clamping feature 114 may be flush with the rest of sample-holding portion 106. First clamping feature 114 includes a first clamping surface 116. For the purposes of this disclosure, a “clamping surface” is a surface that contacts and immobilizes another surface, preventing from slipping or dislodging. In one or more embodiments, at least a portion of first clamping surface 116 may be flat or substantially flat in order to maximize the contact area with a surface it is intended to engage with. In some cases, at least a portion of first clamping surface 116 may be treated (e.g., milled or sanded) to create a frosted, rough surface in order to increase its friction with a surface it is intended to engage with.

With continued reference to FIG. 1, sample-holding portion 106 further includes a first outlet 118 disposed within first clamping surface 116. For the purposes of this disclosure, an “outlet” is an opening through which a certain amount of matter may leave an enclosed system and be removed. In one or more embodiments, first outlet 118 may be disposed opposite to the first inlet 110. As a nonlimiting example, first inlet 110 and first outlet 118 may be disposed at two opposite ends of a right circular cylinder along its axis of rotation. The size of first outlet 118 may be strategically selected, as it determines the contact area between fluid sample 104 and a filtering portion, as described in detail below. The size of first outlet 118 may also determine the size of an observation window when apparatus 100 in placed under a detection system, such as a microscopy, for measurement, as described in detail below. For the purposes of this disclosure, the “size” of an outlet is the longest distance from one side of the outlet to the other, through a straight line. As a nonlimiting example, for an outlet of a circular shape, the size of the outlet may be the diameter of the circle. As another nonlimiting example, for an outlet with an elliptic shape, the size of the outlet may be the length of the major axis of the elliptical shape. As another nonlimiting example, for an outlet with rectangular shape, the size of the outlet may be the length of the diagonal of the rectangular shape. In order to facilitate a rapid sterility testing procedure and reduce/eliminate the need to culture a microbe over an extended period of time, it is often advantages to minimize the size and/or area of first outlet 118. Such small area may ensure that even a trace amount of microbial contaminant may be localized to reach a sufficiently high concentration and become readily observable, thus enabling a rapid and reliable determination of sterility within minutes rather than days, as described in further detail below. In one or more embodiments, first outlet 118 may include a size between 50 micrometers and 60 micrometers, between 60 micrometers and 70 micrometers, between 70 micrometers and 80 micrometers, between 80 micrometers and 90 micrometers, between 90 micrometers and 100 micrometers, between 100 micrometers and 200 micrometers, between 200 micrometers and 300 micrometers, between 300 micrometers and 400 micrometers, between 400 micrometers and 500 micrometers, between 500 micrometers and 600 micrometers, between 600 micrometers and 700 micrometers, between 700 micrometers and 800 micrometers, between 800 micrometers and 900 micrometers, between 900 micrometers and 1 millimeter, between 1 millimeter and 2 millimeters, between 2 millimeters and 3 millimeters, between 3 millimeters and 4 millimeters, between 4 millimeters and 5 millimeters, between 5 millimeters and 6 millimeters, between 6 millimeters and 7 millimeters, between 7 millimeters and 8 millimeters, between 8 millimeters and 9 millimeters, or between 9 millimeters and 1 centimeter.

With continued reference to FIG. 1, apparatus 100 further includes a filter-holding portion 120. For the purposes of this disclosure, a “filter-holding portion” is a structural element that, when engaged against sample-holding portion 106, supports and secures a filtering element or the like. Filter-holding portion 120 includes a second clamping feature 122. Details regarding second clamping feature 122 may be consistent with any details described above pertaining to first clamping feature 114 without limitation. Second clamping feature 122 includes a second clamping surface 124 facing opposite first clamping surface 116. Details regarding second clamping surface 124 may be consistent with any details described above pertaining to first clamping surface 116 without limitation. In some cases, both first clamping surface 116 and second clamping surface 124 may be planar or substantially planar. In some other cases, first clamping surface 116 and second clamping surface 124 may have complementary curvatures in order to efficiently contact and engage with one other. Filter-holding portion 120 further includes a second inlet 126 disposed within second clamping surface 124 and aligned with first outlet 118. Such alignment between second inlet 126 and first outlet 118 is configured to enable fluid sample 104 to pass from sample-holding portion 106 to filter-holding portion 120 and be filtered. In one or more embodiments, filter-holding portion 120 may further include a distal surface 128 opposite to second clamping surface 124.

With continued reference to FIG. 1, filter-holding portion 120 further includes a second outlet 130. Second outlet 130 may be used to drain fluid sample 104 from apparatus 100 after it has been filtered. Second outlet may be disposed at any suitable location within filter-holding portion 120, as recognized by a person of ordinary skill in the art, upon reviewing the entirety of this disclosure. In one or more embodiments, second outlet 130 may be disposed within distal surface 128, as described above. In one or more embodiments, second outlet 130 may be disposed opposite second inlet 126. In one or more embodiments, second outlet 130 may be configured to connect to a pump configured to increase a flow rate of fluid sample 104. Such pump may in some cases be controlled by a computing device. For the purposes of this disclosure, a “pump” is a mechanical apparatus that converts mechanical power into fluidic energy. Pump may include a substantially constant pressure pump (e.g., centrifugal pump) or a substantially constant flow pump (e.g., positive displacement pump, gear pump, and the like). Pump may be hydrostatic or hydrodynamic; hydrostatic pumps are positive displacement pumps; hydrodynamic pumps may be fixed displacement pumps, in which displacement may not be adjusted, or variable displacement pumps, in which the displacement may be adjusted. Pump may generate flow with sufficient power to overcome a pressure induced by a load at a pump outlet. Pump may generate a vacuum at a pump inlet, thereby forcing a fluid from reservoir into the pump inlet to the pump and by mechanical action delivering this fluid to a pump outlet. Nonlimiting examples of pumps may include gear pumps, rotary vane pumps, screw pumps, bent axis pumps, inline axial piston pumps, radial piston pumps, and/or the like. Pump may be powered by any rotational mechanical work source, for example without limitation an electric motor or a power take-off from an engine.

With continued reference to FIG. 1, apparatus 100 further includes a filtering portion 132. For the purposes of this disclosure, a “filtering portion” is a structural element that isolates at least a constituent from a mixture as the mixture passes through it. Filtering portion 132 is securely disposed between first clamping surface 116 and second clamping surface 124 to prevent leakage or bypass. Filtering portion 132 is configured to filter particle 102 from fluid sample 104 that passes between first outlet 118 and second inlet 126. In one or more embodiments, filtering portion 132 may include a semi-permeable membrane. For the purposes of this disclosure, a “semi-permeable membrane” is thin, porous structure that allows certain chemical species to pass through while blocking/retaining others. A semi-permeable membrane may include either a free-standing membrane that requires no support or a disk/pellet pressed from porous, absorbent materials. In some cases, a semi-permeable membrane may permit the passage of smaller chemical species, such as without limitation water, small ions, or certain gases, while restricting larger molecules such as without limitation proteins or larger particles such as without limitation microbes. A semi-permeable membrane used in apparatus 100 may have a pore size between 50 nanometers and 20 micrometers. As nonlimiting examples, the pore size of a semi-permeable membrane may be between 50 nanometers and 60 nanometers, between 60 nanometers and 70 nanometers, between 70 nanometers and 80 nanometers, between 80 nanometers and 90 nanometers, between 90 nanometers and 100 nanometers, between 100 nanometers and 150 nanometers, between 150 nanometers and 200 nanometers, between 200 nanometers and 300 nanometers, between 300 nanometers and 400 nanometers, between 400 nanometers and 500 nanometers, between 500 nanometers and 600 nanometers, between 600 nanometers and 700 nanometers, between 700 nanometers and 800 nanometers, between 800 nanometers and 900 nanometers, between 900 nanometers and 1 micrometer, between 1 micrometer and 2 micrometers, between 2 micrometers and 5 micrometers, between 5 micrometers and 10 micrometers, between 10 micrometers and 15 micrometers, or between 15 micrometers and 20 micrometers. In some cases, a semi-permeable membrane may be constructed using one or more materials such as without limitation polycarbonate (PCTE), cellulose nitrate (CN), cellulose acetate (CA), mixed cellulose ester (MCE), polyethersulfone (PES), regenerated cellulose, glass microfiber, and aluminum oxide, among others, as recognized by a person of ordinary skill in the art, upon reviewing the entirety of this disclosure. With a suitable membrane, apparatus 100 is capable of capturing 100% of microbes (e.g., bacteria) present in fluid sample 104.

With continued reference to FIG. 1, in one or more embodiments, filtering portion 132 may further include a housing element (not shown), wherein semi-permeable membrane is disposed within the housing element. For the purposes of this disclosure, a “housing element” is a structure configured to retain otherwise loose materials within a designated space. In some cases, a housing element may be used to retain porous filtering materials, as described above, and prevent them from leaching into fluid sample 104. In some cases, housing element may be constructed using one or more materials such as without limitation polypropylene (PP), acrylic including acrylic copolymer, polystyrene (PS), and/or polycarbonate (PC), among others, as recognized by a person of ordinary skill in the art, upon reviewing the entirety of this disclosure.

With continued reference to FIG. 1, in one or more embodiments, apparatus 100 may further include a securing mechanism configured to engage second clamping surface 124 against first clamping surface 116, such as without limitation by applying a pressure. In one or more embodiments, second clamping surface 124 may be mounted to first clamping surface 116, or vice versa, using mechanical fasteners including, but not limited to, screws, nuts and bolts, anchors, clips, welding, brazing, crimping, nails, blind rivets, pull-through rivets, pins, dowels, snap-fits, clamps, and/or the like. In one or more embodiments, first clamping surface 116 and second clamping surface 124 may be bound to one another using one or more adhesives, such as without limitation epoxy adhesives, polyurethane adhesives, polyimide adhesives, or the like. As a nonlimiting example, securing mechanism may include a screwing mechanism. Specifically, sample-holding portion 106 may include at least a first mounting slot 134a, and filter-holding portion may include at least a second mounting slot 134b aligned with the at least a first mounting slot 134a. The securing mechanism may accordingly include at least a screw 136 configured to secure filter-holding portion 120 against sample-holding portion 106 by penetrating at least a first mounting slot 134a and at least a second mounting slot 134b. As another nonlimiting example, securing mechanism may include at least a clamp configured to force first clamping surface 116 and second clamping surface 124 against each other by applying pressure in opposite directions. In one or more embodiments, apparatus 100 may further include a sealing element 138 configured to keep filtering portion 132 in place. For the purposes of this disclosure, a “sealing element” is a structure configured to fill empty space and prevent undesired movements of contents therein and/or leakage therefrom. Sealing element may be constructed using any suitable material or design described in this disclosure without limitation.

With continued reference to FIG. 1, in one or more embodiments, apparatus 100 may include at least a first mating feature (not shown) complementary to at least a second mating feature in a detection system, thereby allowing the apparatus 100 to be securely integrated within the detection system for measurement. The features of apparatus 100 described above may facilitate an easy observation of captured microbes, if any. Detection system may include without limitation a microscope, such as a florescence microscope. In some cases, in order to identify and/or quantify a microbe from fluid sample 104, residues remaining on filtering portion 132, within an area outlined by first outlet 118 (i.e., the observation zone) may be subsequently treated using dyes/stains. Excess dyes or stains not absorbed by microbes may be rinsed and subsequently removed from the residues before any measurement is taken. A fluorescence microscope may then be used to scan the observation zone for a presence of microbes, based on a detected fluorescence intensity. Additional details will be provided below in this disclosure.

With continued reference to FIG. 1, For the purposes of this disclosure, a “fluorescence microscope” is a type of optical microscope that uses high-intensity light to promote photoactive, fluorescent molecules to their excited state and detect the light emitted therefrom. In some cases, a fluorescence microscope may allow for a visualization of specific structures or molecules in a sample with high specificity and contrast. Fluorescence microscopes are commonly used in biology and medicine to study cells, tissues, proteins, and other biological molecules. For the purposes of this disclosure, “stains” or “dyes” are chemicals used to color microorganisms, cells, or tissues to make them more visible under a microscope. Dyes or stains may help identify microbial species, assess morphology, and highlight internal structures, among others.

With continued reference to FIG. 1, for the purposes of this disclosure, a pair of “mating features” are two sets of complementary geometric structures, i.e., a first mating feature and a second mating feature, that are capable of interlocking with one another to secure a stable connection in between without slipping over one another. First mating feature may include any component of any latching or fastening apparatus and may latch or fasten to second mating feature, and vice versa. In one or more embodiments, first mating feature may form a mortise-and-tenon combination with second mating feature; the mortise-and-tenon combination may include at least a projection and/or recess in first mating feature that is inserted into and/or penetrated by a corresponding recess and/or projection in second mating feature. As a nonlimiting example, first mating feature may include at least a projection, which may be cylindrical or have any other suitable form, that projects from a surface. Alternatively, and/or additionally, in one or more embodiments, other types of mating mechanisms, such as screws, bolts, snap lock mechanisms, twist lock mechanisms, and/or the like may be used. As a nonlimiting example, one or more mating components may include male grooves that are configured to be inserted into one or more receiving female grooves. Groove may include a tongue and groove, a half lap, a rabbet joint, a biscuit joint, a dowel joint, a dado going, an ordinary male groove, and the like. In one or more embodiments, a mating feature may be further divided into a plurality of mating sub-features, and more than one pair of mating sub-features may be implemented between two elements to further stabilize the connection in between. In one or more embodiments, one or more sets of mating features may be applied to other components of apparatus 100, such as without limitation to secure the attachment between sample-holding portion 106 and filter-holding portion 120, among others.

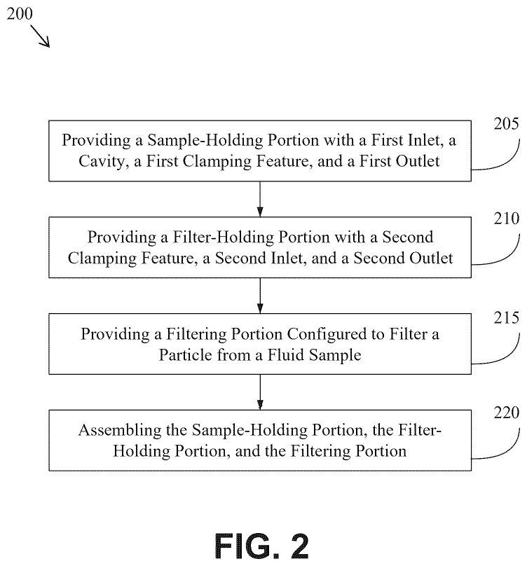

Referring now to FIG. 2, an exemplary embodiment of a method 200 for manufacturing apparatus 100 that separates particle 102 is described. At step 205, method 200 includes providing a sample-holding portion 106, the sample-holding portion 106 including a first inlet 110 configured to receive a fluid sample 104, a cavity 112 configured to contain the fluid sample 104, a first clamping feature 114 having a first clamping surface 116, and a first outlet 118 disposed within the first clamping surface 116. This step may be implemented with reference to details described above in this disclosure and without limitation.

With continued reference to FIG. 2, at step 210, method 200 includes providing a filter-holding portion 120, the filter-holding portion 120 including a second clamping feature 122 having a second clamping surface 124 facing opposite first clamping surface 116, a second inlet 126 disposed within the second clamping surface 124 and aligned with first outlet 118, and a second outlet 130. This step may be implemented with reference to details described above in this disclosure and without limitation.

With continued reference to FIG. 2, at step 215, method 200 includes providing a filtering portion 132, wherein the filtering portion 132 is configured to filter particle 102 from the fluid sample 104. This step may be implemented with reference to details described above in this disclosure and without limitation.

With continued reference to FIG. 2, at step 220, method 200 includes assembling sample-holding portion 106, filter-holding portion 120, and filtering portion 132 by engaging second clamping surface 124 against first clamping surface 116, wherein the filtering portion 132 is securely disposed between first clamping surface 116 and second clamping surface 124. This step may be implemented with reference to details described above in this disclosure and without limitation.

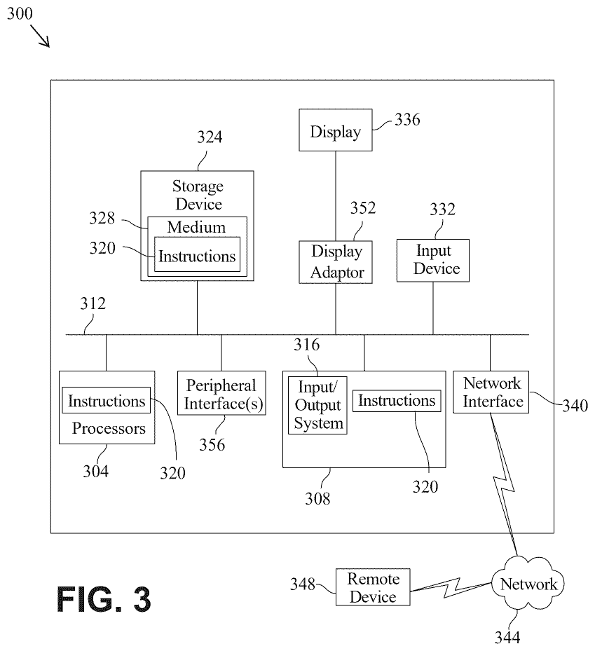

Referring now to FIG. 3, it is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to one of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module. Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission. Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein. Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

With continued reference to FIG. 3, the figure shows a diagrammatic representation of one embodiment of a computing device in the exemplary form of a computing system 300 within which a set of instructions for causing the computing system 300 to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computing system 300 may include a processor 304 and a memory 308 that communicate with each other, and with other components, via a bus 312. Bus 312 may include any of several types of bus structures including, but not limited to, a memory bus, a memory controller, a peripheral bus, a local bus, and any combinations thereof, using any of a variety of bus architectures. Processor 304 may include any suitable processor, such as without limitation a processor incorporating logical circuitry for performing arithmetic and logical operations, such as an arithmetic and logic unit, which may be regulated with a state machine and directed by operational inputs from memory and/or sensors; processor 304 may be organized according to Von Neumann and/or Harvard architecture as a non-limiting example. Processor 304 may include, incorporate, and/or be incorporated in, without limitation, a microcontroller, microprocessor, digital signal processor, field programmable gate array, complex programmable logic device, graphical processing unit, general-purpose graphical processing unit, tensor processing unit, analog or mixed signal processor, trusted platform module, a floating-point unit, and/or system on a chip.

With continued reference to FIG. 3, memory 308 may include various components (e.g., machine-readable media) including, but not limited to, a random-access memory component, a read only component, and any combinations thereof. In one example, a basic input/output system 316, including basic routines that help to transfer information between elements within computing system 300, such as during start-up, may be stored in memory 308. Memory 308 (e.g., stored on one or more machine-readable media) may also include instructions (e.g., software) 320 embodying any one or more of the aspects and/or methodologies of the present disclosure. In another example, memory 308 may further include any number of program modules including, but not limited to, an operating system, one or more application programs, other program modules, program data, and any combinations thereof.

With continued reference to FIG. 3, computing system 300 may also include a storage device 324. Examples of a storage device (e.g., storage device 324) include, but are not limited to, a hard disk drive, a magnetic disk drive, an optical disc drive in combination with an optical medium, a solid-state memory device, and any combinations thereof. Storage device 324 may be connected to bus 312 by an appropriate interface (not shown). Example interfaces include, but are not limited to, small computer system interface, advanced technology attachment, serial advanced technology attachment, universal serial bus, IEEE 1394 (FIREWIRE), and any combinations thereof. In one example, storage device 324 (or one or more components thereof) may be removably interfaced with computing system 300 (e.g., via an external port connector (not shown)). Particularly, storage device 324 and an associated machine-readable medium 328 may provide nonvolatile and/or volatile storage of machine-readable instructions, data structures, program modules, and/or other data for computing system 300. In one example, software 320 may reside, completely or partially, within machine-readable medium 328. In another example, software 320 may reside, completely or partially, within processor 304.

With continued reference to FIG. 3, computing system 300 may also include an input device 332. In one example, a user of computing system 300 may enter commands and/or other information into computing system 300 via input device 332. Examples of input device 332 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 332 may be interfaced to bus 312 via any of a variety of interfaces (not shown) including, but not limited to, a serial interface, a parallel interface, a game port, a USB interface, a FIREWIRE interface, a direct interface to bus 312, and any combinations thereof. Input device 332 may include a touch screen interface that may be a part of or separate from display device 336, discussed further below. Input device 332 may be utilized as a user selection device for selecting one or more graphical representations in a graphical interface as described above.

With continued reference to FIG. 3, user may also input commands and/or other information to computing system 300 via storage device 324 (e.g., a removable disk drive, a flash drive, etc.) and/or network interface device 340. A network interface device, such as network interface device 340, may be utilized for connecting computing system 300 to one or more of a variety of networks, such as network 344, and one or more remote devices 348 connected thereto. Examples of a network interface device include, but are not limited to, a network interface card (e.g., a mobile network interface card, a LAN card), a modem, and any combination thereof. Examples of a network include, but are not limited to, a wide-area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 344, may employ a wired and/or a wireless mode of communication. In general, any network topology may be used. Information (e.g., data, software 320, etc.) may be communicated to and/or from computing system 300 via network interface device 340.

With continued reference to FIG. 3, computing system 300 may further include a video display adapter 352 for communicating a displayable image to a display device, such as display device 336. Examples of a display device include, but are not limited to, a liquid crystal display (LCD), a cathode ray tube (CRT), a plasma display, a light emitting diode (LED) display, and any combinations thereof. Display adapter 352 and display device 336 may be utilized in combination with processor 304 to provide graphical representations of aspects of the present disclosure. In addition to a display device, computing system 300 may include one or more other peripheral output devices including, but not limited to, an audio speaker, a printer, and any combinations thereof. Such peripheral output devices may be connected to bus 312 via a peripheral interface 356. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for separating a particle, the apparatus comprising:
a sample-holding portion, the sample-holding portion comprising:
a first inlet configured to receive a fluid sample;
a cavity configured to contain the fluid sample;
a first clamping feature having a first clamping surface; and
a first outlet disposed within the first clamping surface;
a filter-holding portion, the filter-holding portion comprising:
a second clamping feature having a second clamping surface facing opposite the first clamping surface;
a second inlet disposed within the second clamping surface and aligned with the first outlet; and
a second outlet; and
a filtering portion securely disposed between the first clamping surface and the second clamping surface and configured to filter the particle from the fluid sample that passes between the first outlet and the second inlet.

2. The apparatus of claim 1, wherein the filtering portion comprises a semi-permeable membrane having a pore size between 50 nanometers and 20 micrometers.

3. The apparatus of claim 2, wherein the semi-permeable membrane is constructed using one or more materials selected from a group consisting of polytetrafluoroethylene (PTFE), polyvinylidene fluoride (PVDF), polyethersulfone (PES), polypropylene (PP), nylon, cellulose acetate (CA), regenerated cellulose, glass microfiber, and aluminum oxide.

4. The apparatus of claim 2, wherein:
the filtering portion further comprises a housing element; and
the semi-permeable membrane is disposed within the housing element.

5. The apparatus of claim 4, wherein the housing element is constructed using one or more materials selected from a group consisting of polypropylene (PP), acrylic including acrylic copolymer, polystyrene (PS), polycarbonate (PC), and one or more metals.

6. The apparatus of claim 1, wherein at least a fraction of the sample-holding portion comprises a shape of a cylinder or a prism.

7. The apparatus of claim 1, wherein the first outlet is disposed opposite to the first inlet.

8. The apparatus of claim 1, wherein the first outlet comprises a size between 1 micrometer and 1 centimeter.

9. The apparatus of claim 1, wherein the cavity comprises a volume between 1 microliter (μL) and 10 milliliters (mL).

10. The apparatus of claim 1, wherein the particle comprises a microbe.

11. The apparatus of claim 10, wherein the microbe comprises a bacterium or a fungus.

12. The apparatus of claim 1, wherein the particle comprises a microplastic particle.

13. The apparatus of claim 1, further comprising a securing mechanism configured to engage the second clamping surface against the first clamping surface by applying a pressure.

14. The apparatus of claim 13, wherein:
the sample-holding portion comprises at least a first mounting slot;
the filter-holding portion comprises at least a second mounting slot aligned with the at least a first mounting slot; and
the securing mechanism comprises at least a screw configured to secure the filter-holding portion against the sample-holding portion by penetrating the at least a first mounting slot and the at least a second mounting slot.

15. The apparatus of claim 13, wherein the securing mechanism comprises at least a clamp.

16. The apparatus of claim 1, further comprising a sealing element configured to keep the filtering portion in place.

17. The apparatus of claim 1, wherein the second outlet is disposed opposite to the second inlet.

18. The apparatus of claim 1, wherein the second outlet is configured to connect to a pump configured to increase a flow rate of the fluid sample.

19. The apparatus of claim 1, wherein the apparatus comprises at least a first mating feature complementary to at least a second mating feature in a detection system, thereby allowing the apparatus to be securely integrated within the detection system for measurement.

20. A method for manufacturing an apparatus that separates a particle, the method comprising:
providing a sample-holding portion, the sample-holding portion comprising:
a first inlet configured to receive a fluid sample;
a cavity configured to contain the fluid sample;
a first clamping feature having a first clamping surface; and
a first outlet disposed within the first clamping surface;
providing a filter-holding portion, the filter-holding portion comprising:
a second clamping feature having a second clamping surface facing opposite the first clamping surface;
a second inlet disposed within the second clamping surface and aligned with the first outlet; and
a second outlet;
providing a filtering portion, wherein the filtering portion is configured to filter the particle from the fluid sample; and
assembling the sample-holding portion, the filter-holding portion, and the filtering portion by engaging the second clamping surface against the first clamping surface, wherein the filtering portion is securely disposed between the first clamping surface and the second clamping surface.
